(19) United States
(12) Patent Application Publication
(10) Pub. No.: US 2015/0050429 A1
(43) Pub. Date: Feb. 19, 2015

(54) METHOD FOR MANUFACTURING DECORATIVE PART FOR VEHICLE, AND DECORATIVE PART FOR VEHICLE

(71) Applicant: Yukihiro Goto, Toyota-shi (JP)

(72) Inventor: Yukihiro Goto, Toyota-shi (JP)

(73) Assignee: TRINITY INDUSTRIAL CORPORATION, Toyota-shi, Aichi (JP)

(21) Appl. No.: 14/387,274

(22) PCT Filed: Sep. 14, 2012
(86) PCT No.: PCT/JP2012/074316

§ 371 Date: Sep. 23, 2014

(30) Foreign Application Priority Data
Mar. 28, 2012 (JP) 2012-072787

(51) Int. Cl. B60R 13/02; B05D 3/06

(52) U.S. Cl. CPC B60R 13/02; B05D 3/06
USPC 427/555

(57) ABSTRACT

At least either convex parts 11 set on the surface 3a of a work 2 or concave parts 21 set in a location different from the convex part 11 are formed by laser irradiation. Then, a protective film 71 is formed that covers the surface 3a of the work 2 and the surface 13 of the convex parts 11 and the surface 22 of the concave parts 21.

### TECHNICAL FIELD

This invention relates to a method for manufacturing decorative parts for vehicles, and decorative parts for vehicles, of which method a laser is irradiated onto the surface of a work.

### TECHNICAL BACKGROUND

To improve the design or quality of automotive decoration or the like, many different decorative parts for a vehicle (i.e. console box, instrument panel, arm-rest or the like) are practically used, and such decoration is added to the surface of a work. As a method for enhancing decoration of an automotive decorative part, metallic-molding decorating is suggested (see Patent Document 1). Specifically, it is a technology by which a concave and convex surface is obtained on a work by injection-forming metallic molding so as to provide such a surface texturing on a molded surface.

As a cheap and easy decorative method, laser drawing is used by which a laser is irradiated onto the surface of a work made of a thermoplastic resin, with the heat of the laser changing the work surface, adding decoration to the work. Patent Document 2 refers to a technology for forming fine concave parts onto the surface of a painted interior material (the work) by an irradiating laser.

### PRIOR ART DOCUMENT

Patent Document 1: Unexamined patent application, No. H10-71677 (FIGS. 3, 4 or the like), published in Japanese.
Patent Document 2: Unexamined patent application, No. 2007-269221 (FIGS. 4 to 6 or the like), published in Japanese.

### SUMMARY OF THE INVENTION

### Problems to be Resolved by the Invention

In the case of decoration being added by using a metallic mold, the concave/convex surface of a work is directly formed by the concavity and convexity of the molded surface. Thus, such a metallic mold should be used especially for such decoration. The designs expressed by such a metallic mold are limited. To resolve this problem, it is necessary to increase the variety of decorations. Yet, there is the problem of increasing the number of molds. In the case of a laser being used to add a decorative part, generally only concavity can be formed, thus limiting the designs to be expressed.

This invention was achieved in light of the foregoing problems in providing a method for manufacturing decorative parts for vehicles, which makes it possible in increasing the range of designs and to provide decorative parts for vehicles in a wide range of designs.

### Means for Solving the Problems

To solve the aforementioned problems, the first aspect of this invention refers to a method for manufacturing thermoplastic-resin decorative parts for vehicles by a laser-irradiating process in which a laser is irradiated onto the surface of a work to form at least either convex parts positioned on the surface of the aforementioned work or concave parts positioned in a different location than the convex parts. Then, after such a laser-irradiating process, a protective coating formation process is done to cover the surface of the work and of the convex and concave parts.

The first aspect of this invention allows for the formation of either convex or concave parts by providing for laser energy to be irradiated onto the surface of a work. The further protective coating formation process makes it possible to form a protective coating to cover the surface of the convex and concave parts, thus making it easier to change the reflecting degree of the reflecting light on the area where the convex and concave parts exist or not exist. As such, the protective coating makes it possible to change the colors or to express the richness of the colors, thus making it surely possible to increase the number of design patterns. Moreover, the formed protective coating protects the surface of the work and at least either the surface of the convex or the concave parts, thus increasing the resistance of the work to damage.

Preferably, the thermoplastic resin used in forming decorative parts for vehicles includes ABS (acrylonitrile butadiene styrene) resin, PP (polypropylene) resin, PC/ABS resin, PC (polycarbonate) resin, PMMA (acryl) resin, POM (polyacetal) resin, PBT (polybutylene terephthalate) resin and PET (polyethylene terephthalate resin) resin or the like.

Preferably, the energy density of the laser being irradiated to form the convex parts is greater than that of the laser being irradiated to form the concave parts. As such, the laser being irradiated to form the convex parts has a comparatively higher energy density, thus making it easier to create the foaming phenomenon (that occurs as the laser melts the surface of the work), which makes it possible surely to form the convex parts containing foam.

In the case that the energy density of the laser being irradiated to form the convex parts is greater than that of the laser being irradiated to form the concave parts, the energy density of the laser being irradiated to form the convex parts preferably should be 15 MW/cm² or more, whilst the energy density of the laser being irradiated to form the concave parts preferably should be less than 9 MW/cm². If the energy density of the laser being irradiated to form the convex parts is less than 15 MW/cm² for melting the surface of the work, then foam will not sufficiently form on the melted surface of the work, thus making it unlikely that the convex parts will form. On the other hand, if the energy density of the laser being irradiated to form the concave parts is 9 MW/cm² or more, then the surface of the work onto which the laser is being irradiated will unlikely melt and foam favorably.

Either the same type of laser or a different type of laser can be used to form the convex and concave parts on a work. When different types of lasers are used to form the convex and concave parts, a gas laser can be used to form the convex parts, and a solid-state laser, being lower-powered than a gas laser, can be used to form the concave parts, making it possible then in using a higher-powered laser to form the convex parts than the one used in forming the concave parts. Thus, it is possible to form the convex parts in less time than if they are formed by the same type of laser used in forming the concave parts, thereby improving manufacturing efficiency and the quality of the decorative parts for vehicles. There are gas lasers including the CO₂ laser, the He—Ne laser, the Ar laser and the excimer laser or the like, and there are solid-state lasers including the YAG laser, the ruby laser and the glass laser or the like.

Protective coatings include coating film or plating film or the like but not limited to these. Coating films includes a coating film formed by solid paint, a coating film formed by paint containing a bright material, a water-clear coating film formed by clear paint (having no pigment) or the like. Preferably, the protective coating is a coating film formed by paint containing a brightening material that emits a radiance like a metal or the like within the coating film, thus making it easier to obtain the visual effects given by the coating film. Brightening materials include aluminum powder, tetanized mica-pigment and glass beads or the like. Paints (coating material) containing a brightening material include metallic paint (in which aluminum powder is included in a semi-transparent enamel such as thermoset acrylic paint or the like) and pearl paint (in which tetanized mica-pigment or glass beads are included in the semi-transparent enamel).

The thickness of the protective coating preferably should be from 10 μm to 25 μm for instance but not limited thereto. If the thickness of the protective coating is less than 10 μm, such protective coating is too thin, and the surface of the work and of the convex and concave parts is easily damaged by the touch of the operator's finger. On the other hand, if the thickness of the protective coating covering the convex and concave parts is greater than 25 μm, such parts will be visually unclear, and the protective coating is unlikely to change the reflecting degree of the reflecting light, even if the protective coating is formed.

After the process of forming the protective coating, it is preferable that the process of forming the concave part on the protective coating surface is conducted to form the concave part on a different place than where the protective coating covers the convex part, by irradiating the laser onto the surface of the protective coating. As such, even when forming for example only the convex part in the laser-irradiation process, the concave-part protective coating surface, having the same function as the concave part, is formed in the process of forming the concave-part protective coating surface, thus making it possible surely to increase the number of design patterns.

The second aspect of this invention refers to decorative vehicle parts made of a thermoplastic resin of which the laser-processed part is formed on the surface of the work, and is characterized in that the laser-processed part consists of at least either convex parts formed on the surface of the work or concave parts formed in a different place than the convex parts, and the surface of the work and the surface of the convex and concave parts are covered by a protective coating.

The second aspect of this invention allows for either the convex or concave part to be formed on the surface of a work, and that the surface of either the convex and concave part is covered with a protective coating that makes it easier to change the reflecting degree of the reflecting light on the area where the convex and concave parts exist or not exist. As such, the protective coating makes it possible to change the colors or to express the richness of the colors, thus making it surely possible to increase the number of design patterns. Moreover, the formed protective coating protects the surface of the work and at least either the surface of the convex or concave part, thus increasing the resistance to damage of the work surface and of the convex and concave parts.

In the case that the laser-processed part of the work consists of both convex and concave parts, the width of the convex parts preferably should be less than that of the concave part to make it possible to form fine convex and concave parts. In the case that the convex parts contain air bubbles, then the color-contrast of the convex parts will be great enough for them be seen, even if the width of the concave parts is less than that of the convex parts. Preferably, the width of the convex parts should be from 50 μm to 120 μm. If the width of the convex parts is less than 50 μm, then the volume of such parts will be smaller, thus making it difficult for example to beat air bubbles into the convex parts. On the other hand, if the width of the convex parts is 120 μm or greater, then it will be difficult to form fine convex and concave parts. The width of the concave parts should preferably be from 40 μm to 210 μm on the surface of the work and from 30 μm to 200 μm on the surface of the protective coating. If the width of the concave parts is less than 40 μm on the surface of the work, that is, less than 30 μm on the surface of the protective coating, then the concave-formation area will be too small, which may make it impossible then to see the concave parts. On the other hand, if the width of the concave parts on the work surface is greater than 210 μm, actually greater than 200 μm on the protective coating surface, then it will be difficult to form fine convex and concave parts.

In the case that the laser-processed part of the work consists of both convex and concave parts, the height of the convex parts should be greater than the depth of the convex parts. Such higher convex parts mean greater volume thereof, which makes it easier for example to beat air bubbles into the convex parts. As a result, such convex parts having air bubbles make the contrast of the convex parts greater, thus letting them be seen better. The height of the convex parts should be from 8 μm to 15 μm. If the height of the convex parts is less than 8 μm, then the volume of the convex parts will be less, which makes it difficult for example to beat air bubbles into them. On the other hand, if the height of the convex parts is greater than 15 μm, then the intensity of the convex parts will be lower due to the air bubbles therein, and such convex parts are easily damaged by the touch of the operator's finger. The depth of the concave parts should preferably be from 4 μm to 12 μm on the surface of the work and from 10 μm to 20 μm on the surface of the protective coating. If the depth of the concave parts on the surface of the work is less than 4 μm, and the depth on the surface of the protective coating is less than 10 μm, the contrast of the concave parts will be weaker. Thus, the concave parts are unlikely to be seen. On the other hand, if the depth of the concave parts on the surface of the work is greater than 12 μm, and the depth of the concave parts on the surface of the protective coating is greater than 20 μm, it is difficult to form the concave parts.

The concave parts on the surface of the protective coating should be formed in a different location than the location covering the convex parts. As such, even if only convex parts are formed on the surface of the work, the formation of the concave parts on the protective coating surface having the same function as the concave parts makes it possible surely to increase the range of the design patterns.

### Effect of the Invention

As described above, the first through eleventh aspects of this invention make it possible to widen the range of the design patterns.

### BRIEF DESCRIPTION OF THE DRAWINGS

FIG. 1 is an oblique-perspective drawing showing a decorative part for a vehicle as an embodiment of this invention.

FIG. 2 is a cross-sectional view of FIG. 1, along Line A-A.

FIG. 3 is a major part of the cross-sectional view showing a decorative part for a vehicle.

FIG. 4 is a diagrammatic illustration showing a surface-decorating system.

FIGS. 5 (a) and (b) are explanatory drawings showing the method for manufacturing a decorative part for a vehicle.

FIG. 6 is an explanatory drawing of another embodiment showing the method for manufacturing a decorative part for a vehicle.

FIG. 7 is a major part of a cross-sectional view of another embodiment showing the method for manufacturing a decorative part for a vehicle.

FIG. 8 is an explanatory drawing of another embodiment showing the method for manufacturing a decorative part for a vehicle.

FIG. 9 is a schematic-perspective view showing the work of another embodiment.

### BEST MODE FOR CARRYING OUT THE INVENTION

Hereinafter, the first embodiment of this invention is described in reference to the drawings.

As shown in FIGS. 1 through 3, an automotive decorative part 1 (decorative part for a vehicle) is formed of a black thermoplastic resin (ABS resin is used for this embodiment) incorporating a three-dimensional-shaped work 2. The automotive decorative part 1 of the embodiment is a decorative panel for covering the top surface of an armrest to be provided on a door of a car. The work 2 comprises a convexly curved work surface 3a and a concavely curved rear-work surface 3b set opposite the work surface 3a. A switch-mounting hole 6 for mounting a power-window switch (not shown in the drawing) and a switch-mounting hole 7 for mounting a door-lock switch (not shown in the drawing) is provided on the work 2. The switch-mounting holes 6 and 7 go through the work surface 3a and the rear-work surface 3b.

A decorative area 4 is set on the work surface 3a, except for the switch-mounting holes 6 and 7 of the work 2. Multiple convex parts 11 (laser-processed parts) and multiple concave parts 21 (laser-processed parts) are formed on the decorative area 4 of the work 2. Each convex part 11 of the decorative area 4 linearly extends in the same vertical direction. The convex part 11 is a foamed layer containing multiple air bubbles. The width W1 of the convex part 11 is from 50 μm to 120 μm (100 μm in this embodiment), and the height H1 of the projecting part of the convex part 11 from the work surface 3a is from 8 μm to 15 μm (10 μm in this embodiment).

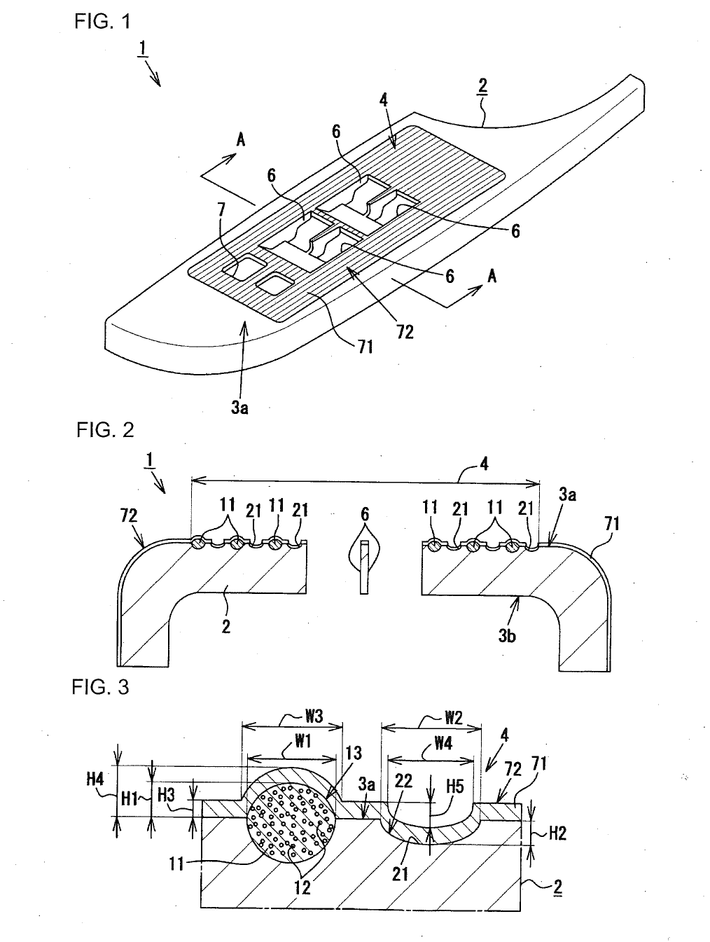

As shown in FIGS. 2 and 3, each concave part 21 is formed on the same work surface 3a but in a different location from the location of each convex part 11. Specifically, each concave part 21 linearly extends in the same vertical direction on the decorative area 4. Each convex part 11 and concave part 21 is alternately allocated in the horizontal direction of the decorative area 4. The width W2 of the concave part 21 on the work surface 3a is from 40 μm to 210 μm, which means that the width W1 (100 μm) of said convex part 11 is less than the width W2 of the concave part 21. The length of the concave part 21 is the same as that of the convex part 11. Thus, the area where the concave part 21 is formed is greater than the area where the convex part 11 is formed. The depth H2 of the concave part 21 on the work surface 3a is from 4 μm to 12 μm (8 μm in this embodiment), which means that the height H1 (10 μm) of the convex part 11 is greater than the height H2 of the concave part 21. Moreover, the distance between the convex part 11 and its adjacent concave part 21 is the same as or shorter than the width W2 of the concave part 21.

As shown in FIGS. 2 and 3, the work surface 3a of the work 2 and the surface 13 of the convex part 11 and the surface 22 of the concave part 21 are covered with the protective coating 71. The protective coating 71 of this embodiment is a coating of film consisting of a metallic paint containing an aluminum powder (brightening agent) having an average particle diameter of from 7 μm to 25 μm (15 μm in this embodiment). The thickness H3 of the protective coating 71 is from 10 μm to 25 μm (15 μm in this embodiment). The width W3 of the convex part 11 on the surface 72 of the protective coating 71 is from 60 μm to 130 μm (130 μm in this embodiment). The width W4 of the concave part 21 on the surface 72 is from 30 μm to 200 μm. The height H4 of the convex part 11 on the surface 72 is from 18 μm to 30 μm (25 μm in this embodiment). The depth H5 of the concave 21 on the surface 72 is from 10 μm to 20 μm (16 μm in this embodiment).

The surface-decorating system 30 for manufacturing the automotive decorative part 1 is described hereinafter.

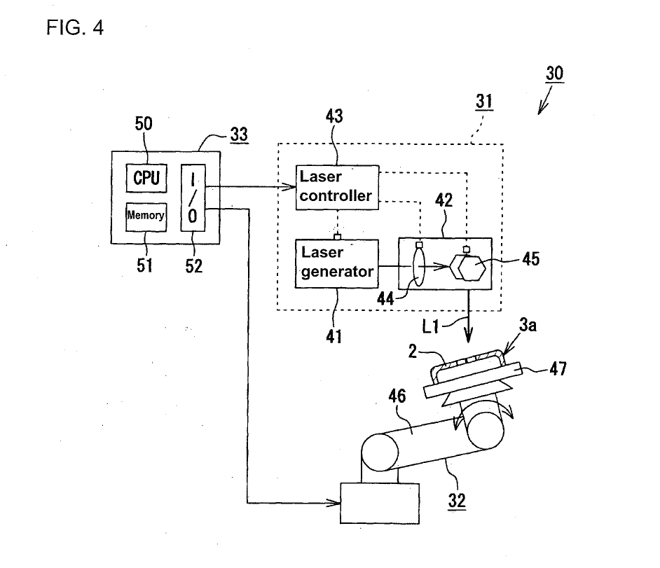

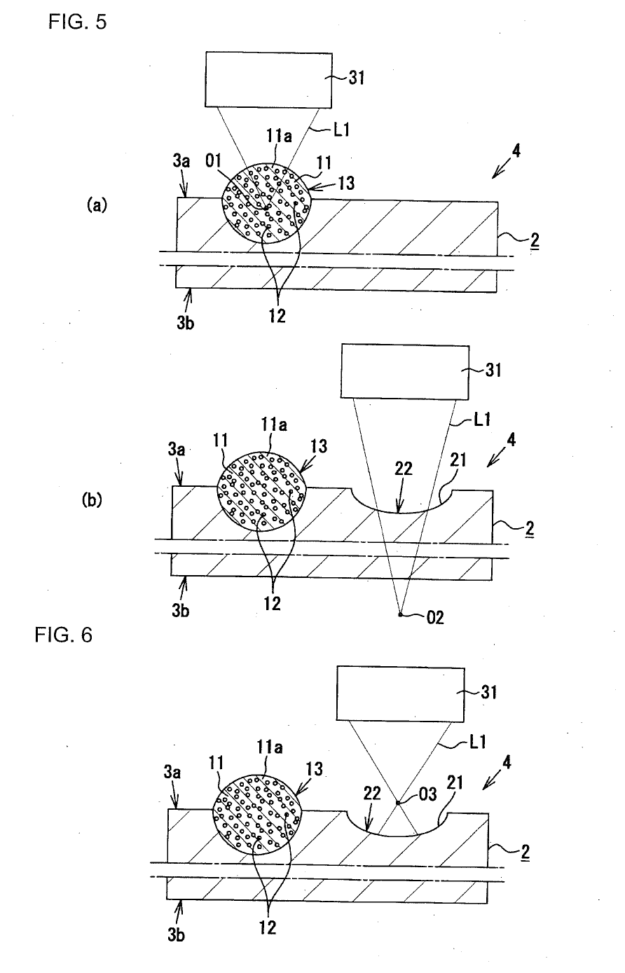

As shown in FIG. 4, the surface-decorating system 30 comprises a laser-irradiating device 31 and a work-displacement robot 32. The laser-irradiating device 31 comprises a laser generator 41 for generating the laser L1 (a YAG laser of a wave length of 1,064 nm in this embodiment) and a laser deflector 42 for deflecting the laser L1 and a laser controller 43 for controlling the laser generator 41 and the laser deflector 42. The laser deflector 42 is a complex optical system comprising a lens 44 and a reflective mirror 45, of which the position of the lens 44 and reflective mirror 45 varies to adjust the position of the focal points O1, O2 (see FIG. 5) in irradiating the laser L1. The laser controller 43 controls the temporal modulation, the intensity modulation and the area modulation and the like in irradiating the laser L1.

The work-displacement robot 32 comprises a robot arm 46 and a work-supporting part 47 provided on the edge of the robot arm 46. The work-supporting part 47 supports the work 2. The work-displacement robot 32 activates the robot arm 46 and varies the position and angle of the work 2 in irradiating the laser L1 onto the surface 3a of the work 2.

An electrical configuration of the surface-decorating system 30 is described hereinafter.

As shown in FIG. 4, the surface-decorating system 30 comprises a control device 33 for controlling the whole system. The control device 33 comprises a well-known computer system such as CPU50, memory 51, and input-output port 52 and the like. The CPU50 is connected electrically to the laser-irradiating device 31 and to the work-displacement robot 32. Each device is controlled by an activating signal.

The memory 51 stores the laser-irradiating data for laser irradiation. The laser-irradiation data is data obtained by converting the CAD data that is obtained by converting the image data of the decorative area 4 on which the convex parts 11 and concave parts 21 are formed. Such image data consists of a graphics area for forming the convex parts 11 and concave parts 21. Multiple graphic dots are sporadically formed (in a reticular pattern in this embodiment) in the graphics area. The memory 51 stores the data of the laser-irradiation parameter (the position to be irradiated by the laser L1, as well as the focal points O1 and O2, the angle, the area, the time, the intensity, the frequency and the pitch or the like).

The method for manufacturing the automotive decorative part 1 is described hereinafter.

First, prepare a specified three-dimensional work 2 that is formed of a black thermoplastic resin (ABS resin in this embodiment). Specifically, conduct the work-forming process to form the work 2 of a metallic mold (not shown in the drawings) having no convex and concave parts (fine convex and concave, here) to form the convex parts 11 and concave parts 21. The operator then sets the work 2 on the work-supporting part 47 (see FIG. 4) of the work-displacement robot 32.

The CPU50 reads out the laser-irradiation data that is stored in the memory 51, and based on that data an activating signal is generated and transmitted to the work-displacement robot 32. The work-displacement robot 32 then activates the robot arm 46, according to the activating-signal generated by the CPU50, to move the work 2 being supported by the work-supporting part 47 to the specified place within the decorative area 4 of the work 2 that is be irradiated by the laser L1. At the same time, the angle of the work 2 being supported by the work-supporting part 47 as well as the angle of the irradiating laser L1 is adjusted.

Then, according to the laser-irradiation data stored in the memory 51, the laser-irradiation process of irradiating the laser L1 onto the decorative area 4 on the surface 3a of the work 2 is conducted.

Specifically, the convex-part forming process is conducted in which the CPU50 reads out the laser-irradiation data stored in the memory 51 and generates the activating signal for forming the convex part 11 based on the laser-irradiation data that was read out and then transmits such activating signal to the laser-irradiation device 31. According then to the activating signal that is transmitted from the CPU50 for forming the convex part 11, the laser-irradiation device 31 irradiates the laser L1 onto the specified area consisting of the decorative area 4 (see FIG. 5(a)). The laser controller 43 of the laser-irradiation device 31 irradiates the laser L1 by the laser generator 41 and controls the laser deflector 42 according to the patterns of the convex part 11. Such control determines the position to be irradiated by the laser L1 to set the focal point O1 of the laser L1 onto the surface of the decorative area 4. The energy density of the laser L1 to be irradiated onto the surface of the decorative area 4 is 15 MW/cm² or more (40 MW/cm² in this embodiment). In this case, the heat of the laser L1 is concentrated onto the surface 3a, and the heat energy increases. The surface of the decorative area 4 then melts, with the top edge 11a of the surface expanding from the surface 3a of the work 2. Thus, the convex part 11 containing air bubbles is formed.

After the irradiation of the laser L1 toward the specified place is done, the CPU50 controls the activation of the robot arm 46 of the work-displacement robot 32 so as to move the work 2 being supported by the work-supporting part 47 to the specified place within the decorative area 4 that is to be irradiated by the laser L1. At the same time, the angle of the work 2 being supported by the work-supporting part 47 as well as the irradiating angle of the laser L1 within the specified area to be irradiated by the laser L1 is adjusted.

Subsequently, conduct the concave-part forming process in which the CPU50 reads out the laser-irradiation data stored in the memory 51 for forming the concave part 21. Based on the laser-irradiation data being read out, the activating signal for forming the concave part 21 is generated and transmitted to the laser-irradiation device 31. Then, the laser irradiation device 31, according to the activating signal being transmitted from the CPU50 for forming the concave part 21, irradiates the laser L1 onto another area (see FIG. 5(b)) of the work 2. The laser controller 43 of the laser-irradiation device 31 controls the laser deflector 42 according to the patterns of the concave part 21, and by the laser generator 41 the laser L1 irradiates. Such control determines the position on another area to be irradiated by the laser L1. Thus, the focal point O2 of the laser L1 moves to the position out of the rear surface 3b of the work 2. Thus, the energy density of the laser L1 to be irradiated onto the surface of the decorative area 4 drops to less than 9 MW/cm² (5 MW/cm² in this embodiment). In this case, even if the laser L1 is irradiated, the air bubbles 12 will not be generated in the melted surface of the decorative area 4. As the surface of the decorative area 4 is sublimed, the concave part 21 is formed on the same work surface 3a but in a different location from the location of each convex part 11.

The energy density of the laser L1 to be irradiated in forming the convex part 11 is greater than the energy density of the laser L1 to be irradiated in forming the concave part 21. As such, the height H1 (10 μm) of the convex part 11 is greater than the depth H2 (8 μm) of the concave part 21. The area to be irradiated by the laser L1 in forming the concave part 21 is greater than the area to be irradiated by the laser L1 in forming the convex part 11. Thus, the area in which the concave part 21 is formed becomes greater than the area in which the convex part 11 is formed.

After the concave-part forming process, conduct the productive-film forming process to form the productive film 71 for covering the surface 3a of the work 2, the surface 13 of the convex part 11, and the surface 22 of the concave part 21. Specifically, the CPU50 generates the activating signal that is transmitted to a coating device (not shown in the drawings). The coating device then allows a coater (not shown in the drawing) to start coating the protective coating 71 according to the activating signal being generated by the CPU50. The coater providing a metallic coating forms the protective coating 71 on the surface 3a of the work 2, on the surface 13 of the convex part 11, and on the surface 22 of the concave part 21. After completion of the metallic coating by the coater, the automotive-decorative part 1, as shown in FIGS. 1 to 3, is obtained.

Therefore, the embodiments of this invention realize the following effects.

The method for manufacturing the automotive-decorative part 1 of this embodiment incorporates a laser-irradiating process to provide the energy for the laser L1 irradiating onto the surface 3a of the work 2 to form the convex part 11 and concave part 21. As such, compared to the case of forming either the convex part 11 or the concave part 21, the method of this invention can extend the range of the design expressions. Also, in the laser-irradiation process, the convex part 11 containing the air bubbles 12 is formed on the work 2, thus obtaining the design of the concave part 11 having a strong contrast. Also, the convex part 11 and the concave part 21 are closely adjacent, and the difference in height from the top edge 11a of the convex part 11 to the bottom surface of the concave part 21 makes it possible to obtain a design having a stronger contrast. Moreover, the protective coating formation process in making the protective coating 71 to cover the surface 13 of the convex part 11 and the surface 22 of the concave part 21 makes it easier to change the reflecting degree of the reflecting light in the area where the convex part 11 and the concave part 21 exist or not exist. Specifically, the brightening agent (aluminum powder) contained in the protective coating 71 is orientated along the work surface 3a, the surface 13 of the convex part 11, and the surface 22 of the concave surface 21, thus providing a different reflection rate (reflecting degree) in the reflecting light being reflected onto the work surface 3a, the surface 13 of the convex part 11, and the surface 22 of the concave part 21. Such a protective coating 71 makes it possible to change the colors or to express the richness of the colors, thus making it surely possible to increase the number of design patterns. Therefore, the design quality required for the work 2 is sufficiently secured.

(2) This embodiment provides the protective coating 71 in the protective coating formation process. Such a protective coating 71 protects the surface 3a of the work 2, the surface 13, and the surface 22 of the convex part 11 and concave part 21, respectively, thus increasing the resistance of the work surface 3a to damage.

(3) Conventionally, it is considered possible to form the fine convex part 11 and concave part 21 on the work surface 3a of the work 2 by using metallic injection molding. However, it is necessary then to provide the fine convex part and concave part on the forming-surface of the metallic mold, which is difficult to achieve. In this embodiment, instead, the convex part 11 and the concave part 21 are formed by irradiating the laser L1 onto the work surface 3a that omits providing a fine convex part 11 and concave part 21 on the forming-surface of the metallic mold, thus making it easier to form the fine convex part 11 and concave part 21 on the work surface 3a of the work 2.

(4) The automotive decorative part 1 of this embodiment is formed of a black thermoplastic resin, that is, of a dark-colored material that readily absorbs heat. Compared to the case of an automotive decorative part 1 being formed of a light-colored material, in this embodiment the energy of the laser L1 can easily be exchanged for the heat on the surface of the work 2, which makes it possible to form the convex part 11 and the concave part 21 in a short time. Therefore, the production of the automotive-decorative part 1 is efficiently improved.

The embodiment of this invention can be modified as follows.
As described in the above embodiment, in the concave-part formation process the concave part 21 is formed by irradiating the laser L1 from the surface of the work 2 to the focal point O2 set to the position out of the rear surface 3b (see FIG. 5(b)). However, as shown in FIG. 6, it is possible to form the concave part 21 by irradiating the laser L1 to the focal point O3 set to the position out of the surface 3a.
As described in the above embodiment, after all of the convex parts 11 are formed in the convex-part formation process, then all of the concave parts 21 are formed in the concave-part formation process. However, it is also possible to form all of the convex parts 11 in the convex-part formation process after completion of forming all of the concave parts 21 in the concave-part formation process. Moreover, it is possible to form the convex parts 11 and the concave parts 21, one by one, by alternating the convex-part and concave-part formation processes.

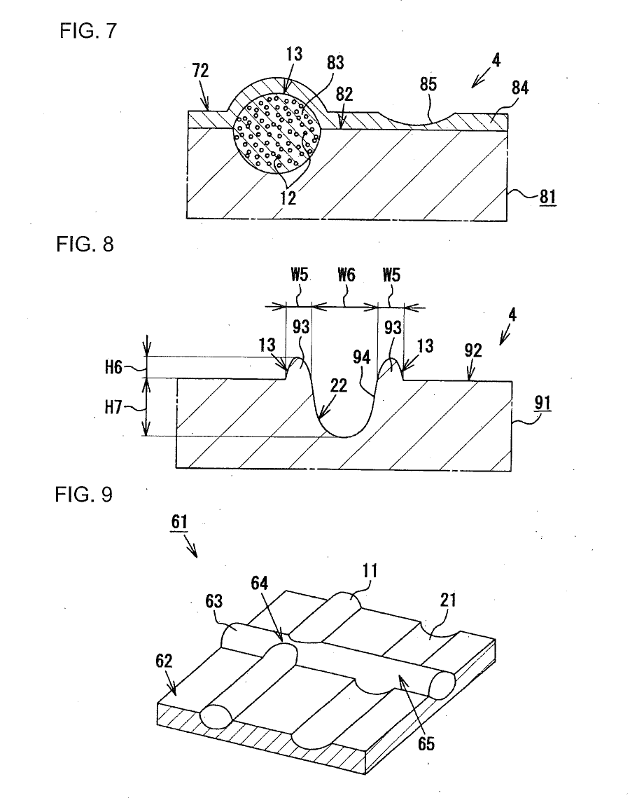

It is possible to form only the convex part 11 in the single convex-part formation process, or it is possible to form only the concave part 21 in the single concave-part formation process. As shown in FIG. 7, in the case that only a convex part 83 is formed on the work surface 82 of the work 81, it is preferable to proceed with the concave-part formation process on the protective coating surface after completion of the protective coating formation process. In the concave-part formation process on the protective coating surface, the concave part 85 of the protective coating surface is formed in a different position than the position to cover the convex part 83 with the protective coating 84 by irradiating the laser onto the surface of the protective coating 84. The depth of the concave part 85 on the protective coating surface is set to extend so as not to pass through the protective coating 84 (8 μm here in this embodiment). As such, even when forming, for example, only the convex part 83 in the laser-irradiation process, the concave part 85 on the protective coating surface, having the same function as the concave part 85, is formed in the concaved protective coating-surface forming process, thus making it possible surely to increase the design patterns. Also, in the case that the convex part 83 and concave part 85 are both formed, or that only the concave part 85 is formed in the laser-irradiation process, it is possible to form the concave part 85 on the protective coating surface in the process of forming the concave part 85 on the protective coating surface.

As shown in FIG. 8, it is possible to form a convex part 93 and concave part 94 simultaneously on the work surface 92 of the work 91 by conducting the process of forming the convex and concave parts simultaneously. Specifically, irradiate the laser L1 having a higher energy density than the laser L1 of the above embodiment (50 MW/cm² here in this embodiment). As such, the concave part 94 having a greater depth than the concave part 21 of the above embodiment is formed. Subsequently, the opening edge of the concave 94 is melted, and the top edge expands from the surface 3a of the work 2 to form the convex part 93. Also, the width W5 of the convex part 93 is set narrower than the width W6 of the concave part 94 on the work surface 92. The height H6 of the concave part 93 is set shorter than the depth H7 of the concave part 94 based on the work surface 92.
In the laser-irradiation process of the above embodiment, the convex part 11 and the concave part 21 are formed by irradiating the laser L1 onto the work surface 3a of the work 2. However, it is possible to form the convex part 11 and the concave part 21 by forming a coating film having no brightening agent onto the surface of the work and by irradiating the laser L1 thereon.
In the above embodiment, the laser L1 used in forming the convex part 11 and the one used in forming the concave part 21 are both a YAG laser. However, it is possible to use different types of lasers in forming the convex part 11 and concave part 21. For instance, it is possible to replace the laser L1 with a CO₂ laser in forming the convex part 11 and to replace the laser L1 with a YAG laser in forming the concave part 21.
In the work 2 of the above embodiment, the convex part 11 and the concave part 21 are horizontally allocated. However, as shown in FIG. 9, it is possible to form another convex part 63 on the work surface 62 of the work 61 and to allocate that convex part 63 to cross the convex part 11 and concave part 21 orthogonally. The height of the joint area 64 of the convex part 63 and the convex part 11 is approximately 12 μm from the work surface 62, and the height of the joint area 65 of the convex part 63 and the concave part 21 is approximately 4 μm from the work surface 62. The joint angle of the convex part 63 and the convex part 11 or the concave part 21 can be arbitrarily determined.
In the above embodiment, the automotive-decorative part 1 is embodied as an armrest for a door. However it is possible that it be embodied as other parts such as a console box or an instrument panel or the like.

Besides the technical ideas of this invention as described above, other technical ideas to be understood are described hereinafter.
(1) As the first aspect of this invention, the method for manufacturing the decorative part for a vehicle is characterized in that is comprises either the convex-part forming process to form the convex part on the surface of the work by irradiating the laser to the focal point set on the surface of the work in the laser-irradiation process or the concave-part forming process to form the concave part on a different position than the convex part by irradiating the laser onto the surface of the work through the focal point set on the position out of the front surface or out of the rear surface of the work surface.
(2) As the first aspect of this invention, the method for manufacturing the decorative part for a vehicle is characterized in that the surface of the work consists of a coating film containing no brightening agent, which is formed on the work itself or on the surface of the work.
(3) As the first aspect of this invention, the method for manufacturing the decorative part for a vehicle is characterized in that before the laser-irradiation process, the work-formation process to form the work is conducted by using a metallic mold having neither a convex part nor a concave part to form the convex part and concave part.

### DESCRIPTION OF THE REFERENCE SIGNS

1: Decorative part for vehicle, as an automotive decoration
2, 61, 81, 91: Work
3a, 62, 82, 92: Work surface, as the surface of the work
11, 63, 83: Convex part, as a laser-processed part
13: Surface of convex part
21, 94: Concave part, as a laser-processed part
22: Surface of concave part
71, 84: Protective coating
72: Surface of the protective coating
85: Concave part on the protective coating surface
H1: Height of the convex part
H2, H5, H7: Depth of the concave part
H3: Thickness of the protective coating
L1: Laser
W1, W5: Width of the convex part
W2, W4, W6: Width of the concave part

1. A method for manufacturing thermoplastic-resin decorative parts for vehicles, characterized by a laser-irradiating process in which a laser is irradiated onto the surface of a work to form at least either convex parts positioned on the surface of the aforementioned work or concave parts positioned in a different location than the convex parts, and by laser-irradiating process in which a protective coating formation process is done to cover the surface of the work and of the convex and concave parts.

2. A method for manufacturing decorative parts for vehicles according to claim 1, characterized in that the protective coating is a coating film formed by paint containing a brightening material.

3. A method for manufacturing decorative parts for vehicles according to claim 2, characterized in that the thickness of the protective coating is from 10 μm to 25 μm.

4. A method for manufacturing decorative parts for vehicles according to claim 1, characterized in that after the process of forming the protective coating, the process of forming the concave parts on the protective coating surface to form the concave parts on a different place than where the protective coating covers the convex parts is conducted by irradiating the laser onto the surface of the protective coating.

5. A method for manufacturing decorative parts for vehicles according to claim 1, characterized in that the energy density of the laser being irradiated to form the convex parts is 15 MW/cm² or more, and the energy density of the laser being irradiated to form the concave parts preferably is less than 9 MW/cm².

6. Thermoplastic-resin decorative parts for vehicles, characterized in that the laser-processed part consists of at least either convex parts formed on the surface of the work or concave parts formed in a different place than the convex parts, and that the surface of the work and the surface of the convex and concave parts are covered by a protective coating.

7. Decorative parts for vehicles according to claim 6, characterized in that the aforementioned protective coating is a coating film formed by paint containing a brightening material.

8. Decorative parts for vehicles according to claim 7, characterized in that the thickness of the aforementioned protective coating is from 10 μm to 25 μm.

9. Decorative parts for vehicles according to claim 6, characterized in that the concave parts are formed on a different place than where the protective coating covers the convex parts.

10. Decorative parts for vehicles according to claim 6, characterized in that the width of the aforementioned convex part is from 50 μm to 120 μm, and the height of the aforementioned convex part is from 8 μm to 15 μm.

11. Decorative parts for vehicles according to claim 6 characterized, in that the width of the aforementioned concave parts is from 40 μm to 210 μm on the surface of the work, and from 30 μm to 200 μm on the surface of the protective coating, and that the depth of the concave parts is from 4 μm to 12 μm on the surface of the work, and from 10 μm to 20 μm on the surface of the protective coating.

12. A method for manufacturing decorative parts for vehicles according to claim 2, characterized in that after the process of forming the protective coating, the process of forming the concave parts on the protective coating surface to form the concave parts on a different place than where the protective coating covers the convex parts is conducted by irradiating the laser onto the surface of the protective coating.

13. A method for manufacturing decorative parts for vehicles according to claim 2, characterized in that the energy density of the laser being irradiated to form the convex parts is 15 MW/cm² or more, and the energy density of the laser being irradiated to form the concave parts preferably is less than 9 MW/cm².

14. Decorative parts for vehicles according to claim 7, characterized in that the concave parts are formed on a different place than where the protective coating covers the convex parts.

15. Decorative parts for vehicles according to claim 7, characterized in that the width of the aforementioned convex part is from 50 μm to 120 μm, and the height of the aforementioned convex part is from 8 μm to 15 μm.

16. Decorative parts for vehicles according to claim 7 characterized, in that the width of the aforementioned concave parts is from 40 μm to 210 μm on the surface of the work, and from 30 μm to 200 μm on the surface of the protective coating, and that the depth of the concave parts is from 4 μm to 12 μm on the surface of the work, and from 10 μm to 20 μm on the surface of the protective coating.
